(19) United States
(12) Patent Application Publication
(10) Pub. No.: US 2005/0174602 A1
(43) Pub. Date: Aug. 11, 2005

(54) Image processing apparatus

(75) Inventor: Daijiro Saito, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Business Technologies, Inc., Tokyo (JP)

(21) Appl. No.: 10/969,462

(22) Filed: Oct. 20, 2004

(30) Foreign Application Priority Data
Feb. 10, 2004 (JP) 2004-032777
Sep. 3, 2004 (JP) 2004-257077

(51) Int. Cl. G06F 15/00

(52) U.S. Cl. 358/1.16

(57) ABSTRACT

An image processing apparatus includes: an input device for obtaining image data and/or an output device for outputting an image corresponding to the image data; a buffer memory for temporarily storing the image data; an input/output unit for executing input/output processing of the image data between the input device and/or the output device and the buffer memory; a storage for storing the image data; an image data transfer bus to which the buffer memory and the storage are connected; and a transfer unit for executing transfer processing of the image data between the buffer memory and the storage through the image data transfer bus, wherein the image data transfer bus is connected to another bus via a bus bridge.

### BACKGROUND OF THE INVENTION

1. Field of the Invention

The present invention relates to an image processing apparatus such as a digital copier, comprising an input device for reading an original image and an output device for forming and outputting an image on a sheet.

2. Description of Related Art

In an image processing apparatus such as a digital copier, when image data is inputted from an input device for reading an original image and outputted to an electrophotographic system output device, an image memory comprising a high speed semiconductor memory so as to smoothly input/output the image data while following the operation of these input/output devices, is used as an input/output buffer.

The image memory is usually connected and managed under a memory control unit. The input/output of the image data between the input/output devices and the image memory is performed via the memory control unit. This memory control unit is also connected to a backbone bus to which another input/output device such as a display device, a control CPU, a print controller and the like are connected. It is possible to access the image memory from the backbone bus via the memory control unit.

According to the above configuration, for example, every processing such as the processing for transferring image data to the display unit and the processing that the print controller transfers image data developed by the memory control unit to the image memory is executed through the backbone bus. Therefore, there is a problem that the load for the backbone bus is high and the processing speed is decreased.

Consequently, an image formation apparatus which is designed to independently perform the processing for reading and outputting the image data stored in the image memory and other input/output processing, via each of general purpose buses provided respectively, is proposed (JP-Tokukaihei-9-186836A).

In the case where a plurality of sets of originals are copied by a digital copier, it is necessary to once store the original images of all the pages, in an image memory. Therefore, the image memory having sufficient storage capacity which is, for example, for 100 or more pages, is applied.

Incidentally, the amount of data of image data to be dealt with has been increased, because of high resolution, colorization, multi-gradation or the like of an image. Therefore, it is intended that a storage which is comparatively low in price and has a large capacity is used as the image memory. However, the access speed of the storage such as a hard disk device or the like is slow in comparison with a semiconductor memory, and the storage such as a hard disk device or the like lacks real time response.

Therefore, the communication with the input/output devices is executed as usual by using the image memory comprising high speed semiconductor memory, and the transfer processing for transferring the image data from the image memory to the hard disk device or the like in order to temporarily store it on the occasion of the input and for returning the image data temporarily stored in the hard disk device or the like to the image memory on the occasion of the output, is required.

If the transfer processing of the image data to the hard disk device or the like is executed through the general purpose bus, because the amount of the image data to be transferred is enormous, the backbone bus is almost occupied by the transfer processing, and the smooth execution of other processing is affected. In particular, in the case where a color image is dealt with, the image data is usually dealt with by dividing in a plurality of basic colors such as Y (yellow), M (magenta), C (cyan), K (black) or the like. Therefore, because the amount of the data is further increased, an efficient transfer processing is strongly desired.

### SUMMARY OF THE INVENTION

The present invention is provided in view of the above problems. An object of the present invention is to provide an image processing apparatus which can efficiently execute transfer processing without affecting other processing when image data is transferred from an image memory to another storage in order to temporarily store it and is returned to the image memory.

To solve the above problem, according to an aspect of the present invention, an image processing apparatus comprises:

an input device for obtaining image data and/or an output device for outputting an image corresponding to the image data;

a buffer memory for temporarily storing the image data;

an input/output unit for executing input/output processing of the image data between the input device and/or the output device and the buffer memory;

a storage for storing the image data;

an image data transfer bus to which the buffer memory and the storage are connected; and

a transfer unit for executing transfer processing of the image data between the buffer memory and the storage through the image data transfer bus,

wherein the image data transfer bus is connected to another bus via a bus bridge.

Incidentally, the bus bridge is the device stands between the buses, and allows each of the buses to transfer the data in its own bus independently. In addition, the bus bridge transfers the data between the buses when there is the access requirement from the bus on one side to the bus on the other side. The bus bridge may connect the buses of the same standard; on the other hand, the bus bridge may also connect the buses of different standards. For example, the clock frequencies in the buses may be the same or different from each other between the buses taking the bus bridge therebetween. Further, the clock frequencies may be synchronous or asynchronous.

Preferably, a PCI bus (Peripheral Components Interconnect bus) or the like is used for the image data transfer bus or another bus. Another bus is a system bus of the image processing apparatus, another image data transfer bus or the like. That is, when there are a plurality of image data transfer buses, another image transfer bus can be the partner for the connection via the bus bridge. The bus bridges may be directly connected each other by the bus bridge or may be indirectly connected each other via the bus of another type such as the system bus connected by the bus bridge.

Preferably, the transfer unit performs as a bus master to transfer the image data. More preferably, the transfer unit can execute the burst transfer. The input/output unit may be the unit for directly reading/writing the data from/to the buffer memory, or may be the unit for executing the input and/or output of the data between the input device and/or the output device and the buffer memory via the image data transfer bus which is the downstream local bus of the bus bridge.

A semiconductor memory capable of high speed accessing such as a SDRAM (Synchronous DRAM) or the like, is used for the buffer memory. The buffer memory may be directly connected to the image data transfer bus, or may be connected via a predetermined memory controller. Preferably, the access from the image data transfer bus side to the buffer memory is controlled via the memory controller. In addition, it is preferable that the functions as the input/output unit is provided to the memory controller and the access collision of the access from the input/output device side and the access from the image data transfer bus side is controlled by the memory controller.

Preferably, the capacity of the storage is considerably larger than that of the buffer memory. For example, a hard disk drive that is capable of increasing its capacity because of being cheap is used. Further, a magnetooptical disk, a rewritable compact disk drive, a DVD (Digital Versatile Disk) or the like may be used as the storage.

Preferably, the apparatus deals with a color image. In this apparatus, the buffer memories, the input/output units, the storages, the image data transfer buses and the transfer units are provided for each of basic colors which forms the color image, and each of the image data transfer buses is connected to another bus via the bus bridge.

Preferably, a DMA transfer is independently executed in each of the image data transfer bus separated by the bus bridge.

Preferably, the apparatus further comprises image memory blocks for each of the basic colors, each of the image memory blocks comprising the buffer memory, the input/output unit, the storage and the transfer unit. The image memory block is connected via the bus bridge, and controlled by one CPU.

Preferably, the transfer processing is executed in an interval of the input/output processing.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a block diagram showing a circuit configuration of the principal part of a color image formation apparatus related to the embodiment of the present invention;

FIG. 2 is a schematic section view showing the color image formation apparatus related to the embodiment of the present invention;

FIG. 3 is a block diagram showing a schematic circuit configuration of the color image forming apparatus related to the embodiment of the present invention;

FIG. 4 is an explanatory diagram showing a data flow in an image memory block of the color image formation apparatus related to the embodiment of the present invention;

FIG. 5 is a block diagram showing a schematic circuit configuration of the image block where one image data transfer bus is shared by Y color and C color and the other image data transfer bus is shared by M color and K color;

FIG. 6 is a timing diagram showing an example of the relationship between an image formation period in which output processing of image data to a printer unit is executed and an executable period in which transfer processing via an image data transfer bus is executed;

FIG. 7 is a timing diagram showing another example of the relationship between the image forming period in which the output processing of the image data to the printer unit is executed and the executable period in which the transfer processing via the image data transfer bus is executed; and

FIG. 8 is a block diagram showing a schematic circuit configuration of the image block where the image blocks for all basic colors are connected to a common image data transfer bus respectively.

### PREFERRED EMBODIMENTS OF THE INVENTION

Hereinafter, an embodiment of the present invention will be described on the basis of the drawings.

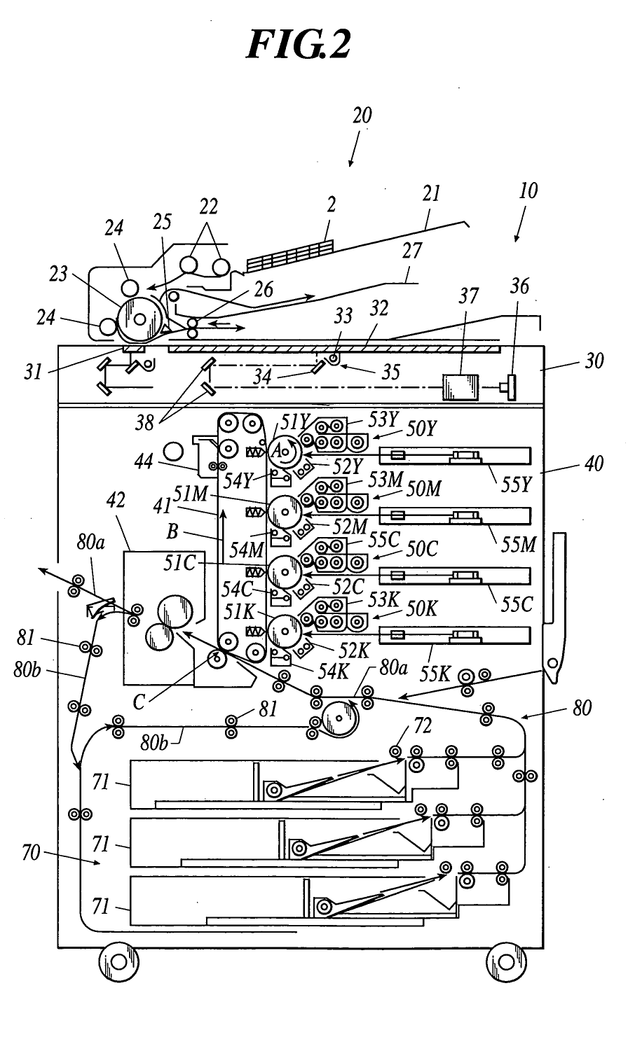

FIG. 2 is a section view showing a schematic configuration of a color image formation apparatus 10 as an image processing apparatus related to the embodiment of the present invention. The color image formation apparatus 10 is the apparatus described as a color digital copier. The color image formation apparatus 10 reads an original image in color, and forms the color image of the duplicate of the original image onto a sheet to output it.

The color image formation apparatus 10 comprises an automatic document feeder 20, a read unit 30 as an input device and a printer unit 40 as an output device. The automatic document feeder 20 transfers originals 2 placed on an document placing tray 21 piece by piece to a reading point of the read unit 30, and discharges the original the reading of which is completed to a paper exit tray 27. Further, for double-sided originals, the automatic document feeder 20 reverses the original after one side of the original is read, and again transfers the original to the read unit 30.

The automatic document feeder 20 comprises a paper feed roller 22 for transferring the originals placed on the document placing tray 21 in order, from the top of the originals, a close contact roller 23 for making the original pass through a contact glass 31 where the original is read, while contacting the original with the contact glass 31, and a guide roller 24 for guiding the original transferred by the paper feed roller 22 along the close contact roller 23. The automatic document feeder 20 further comprises a switching claw 25 for switching the moving direction of the original which passed through the contact glass 31, a reverse roller 26 for reversing the side of a double-sided original, the paper exit tray 27 to which the original the reading of which is completed is exited, and the like.

The read unit 30 reads an original in color. In detail, the read unit 30 outputs image data for each of four basic colors of yellow (Y), magenta (M), cyan (C) and black (K).

The read unit 30 comprises an exposure scan unit 35 which includes a light source 33 and a mirror 34, a color system line image sensor 36 for receiving reflected light from the original and outputting electric signals for each color, which corresponds to the light intensity of the reflected light, a condenser lens 37 for condensing the reflected light from the original to the line image sensor 36, and various types of mirrors 38 for forming an optical path which leads the reflected light from the mirror 34 of the exposure scan unit 35 to the line image sensor 36.

When the read unit 30 reads the original transferred by the automatic document feeder 20, the exposure scan unit 35 moves to the reading point under the contact glass 31 and stops there. Then, the read unit 30 reads the original which is moved over the exposure scan unit 35 by transferring by the close contact roller 23. When the read unit 30 reads the original placed on the platen glass 32, the exposure scan unit 35 moves from left to right along the under surface of the platen glass 32 to read the original which remains stationary.

The printer unit 40 is a tandem system color printer which utilizes an electrophotographic system. The printer unit 40 comprises an endless belt-like intermediate transfer belt 41, a plurality of image formation units 50 Y, 50M, 50C and 50K each of which forms a single color image on the intermediate transfer belt 41, a paper feed section 70 for feeding transfer paper, a conveying section 80 for conveying the fed transfer paper, and a fixing unit 42.

The image formation unit 50Y comprises a cylindrical photoconductor drum 51Y on which an electrostatic latent image is formed. The image formation unit 50Y further comprises an electrification unit 52Y, a development unit 53Y and a cleaning unit 54Y, which are placed around the photoconductor drum 51Y respectively. The image formation unit 50Y further comprises a laser unit 55Y which comprises a laser diode, a polygon mirror, various types of lenses and mirrors and the like.

The photoconductor drum 51Y is driven by a drive unit which is not shown, to rotate in the predetermined direction (the direction indicated by an arrow A in FIG. 2). Then, the electrification unit 52Y makes the photoconductor drum 51 electrify uniformly. The laser unit 55Y forms an electrostatic latent image on the photoconductor drum 51Y by irradiating a laser light which is turned on and off according to Y color image data, to the photoconductor drum 51Y. The development unit 53Y develops the electrostatic latent image with yellow toner. Then, the toner image is transferred onto the intermediate transfer belt 41 at the point where the toner image comes in contact with the intermediate transfer belt 41. The cleaning unit 54Y removes the toner which remains on the photoconductor drum 51 after the transfer, by scrubbing the toner with a blade or the like, and collects the toner.

Each of the image formation unit 50M, the image formation unit 50C, and the image formation unit 50K comprises the same configuration as that of the image formation unit 50Y except that the colors of toner are different from each other and each of the laser is turned on and off according to the image data corresponding to each color. Therefore, the explanations of the image formation units 50M, 50C, and 50K will be omitted. Incidentally, each of the components of the image formation units 50M, 50C, and 50K, which is the same as that of the image formation unit 50Y, has the symbol the number of which is the same as that of the image formation unit 50Y and the subscript of which is M, C or K instead of Y.

The intermediate transfer belt 41 belts a plurality of rollers, and is supported rotatably. The intermediate transfer belt 41 is rotated by a drive unit which is not shown, in the direction indicated by an arrow B in FIG. 2. In the process of the rotation, the images having each of colors are formed on the intermediate transfer belt 41 in order of Y, M, C and K by the image formation units 50Y, 50M, 50C and 50K respectively, in the state where the images having each of colors are superposed on each other. Consequently, a color image is synthesized. This color image is transferred from the intermediate transfer belt 41 onto the transfer paper, at a second transfer point C which is provided at the lower part of the round path of the intermediate transfer belt 41. The toner which is remained on the intermediate transfer belt 41 after the transfer, is removed by the cleaning unit 44.

The image formation by the image formation unit 50Y, the image formation unit 50M, the image formation unit 50C and the image formation unit 50K is executed in the order of Y, M, C and K, with a little delay respectively. That is, the image formation by the image formation unit 50M is started with a delay by the time required for the intermediate transfer belt 41 to move from the front of the image formation unit 50Y to the front of the image formation unit 50M. Similarly, the image formation by the image formation unit 50C is executed with a delay by the time required for the intermediate transfer belt 41 to move from the front of the image formation unit 50M to the front of the image formation unit 50C. Further, the image formation by the image formation unit 50K is executed with a delay by the time required for the intermediate transfer belt 41 to move from the front of the image formation unit 50C to the front of the image formation unit 50K.

The paper feed section 70 feeds the transfer paper stored in each of paper feed cassettes piece by piece from the top of the transfer paper by a first paper feed roller 72 toward the conveying section 80. The conveying section 80 comprises a normal path 80a for making the transfer paper which is fed from the first paper feed roller 72, pass through the second transfer point C and the fixing unit 42 and for exiting the transfer paper to the exit tray outside of the color image formation apparatus 10. The conveying section 80 further comprises a reverse path 80b for reversing the side of the transfer paper which has passed through the fixing unit 42 and for making the transfer paper merge into the normal path 80a again at the upstream of the second transfer point C after the reversing. Each of the paths 80a and 80b comprises a number of conveying rollers 81 each of which is placed with the interval shorter than the size in the conveying direction of the minimum transfer paper.

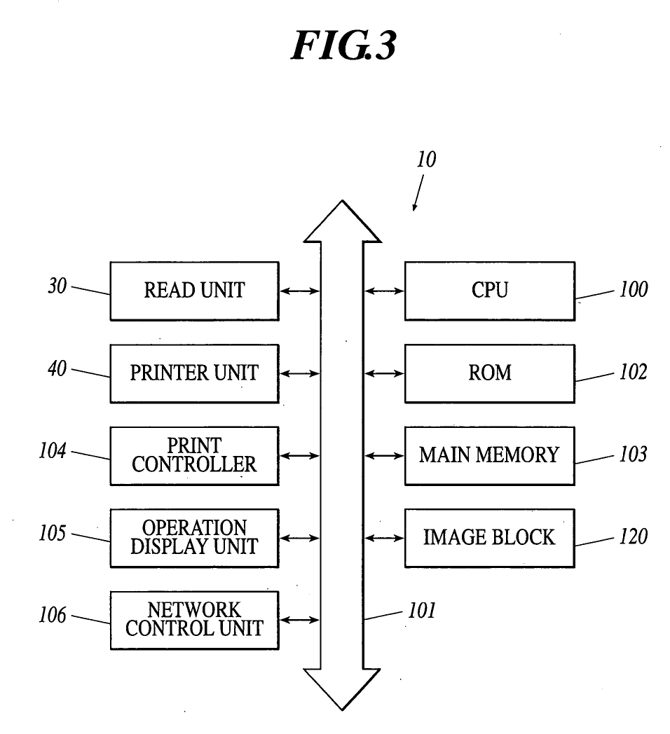

FIG. 3 shows a schematic electric configuration of the color image formation apparatus 10. The color image formation apparatus 10 comprises a CPU (Central Processing Unit) 100 for panoptically controlling the operation of the apparatus. In addition to the read unit 30 and the printer unit 40, a ROM (Read Only Memory) 102, a main memory 103, a print controller 104, an operation display unit 105, a network control unit 106, an image block 120 and the like are connected to the CPU 100 through a system bus 101.

The ROM 102 stores various types of programs to be executed by the CPU 100, and fixed data. The main memory 103 comprises, for example, a RAM (Random Access Memory), and is utilized as a work memory of the CPU 100.

The print controller 104 develops the print data received from external equipment such as a personal computer, into the image data. The operation display unit 105 performs various types of guidance display of status display to a user, and for receiving various types of operation from the user. The operation display unit 105 comprises, for example, a liquid crystal display which is provided with a touch panel thereon, various types of operation switches, an operation unit control CPU for controlling these liquid crystal display and operation switches, and the like.

The network control unit 106 is a circuit for providing and receiving various types of data with external computer apparatus or the like through a network such as LAN (Local Area Network). The image block 120 is a circuit block for mainly processing image data to be inputted from the read unit 30, or image data to be output to the printer unit 40.

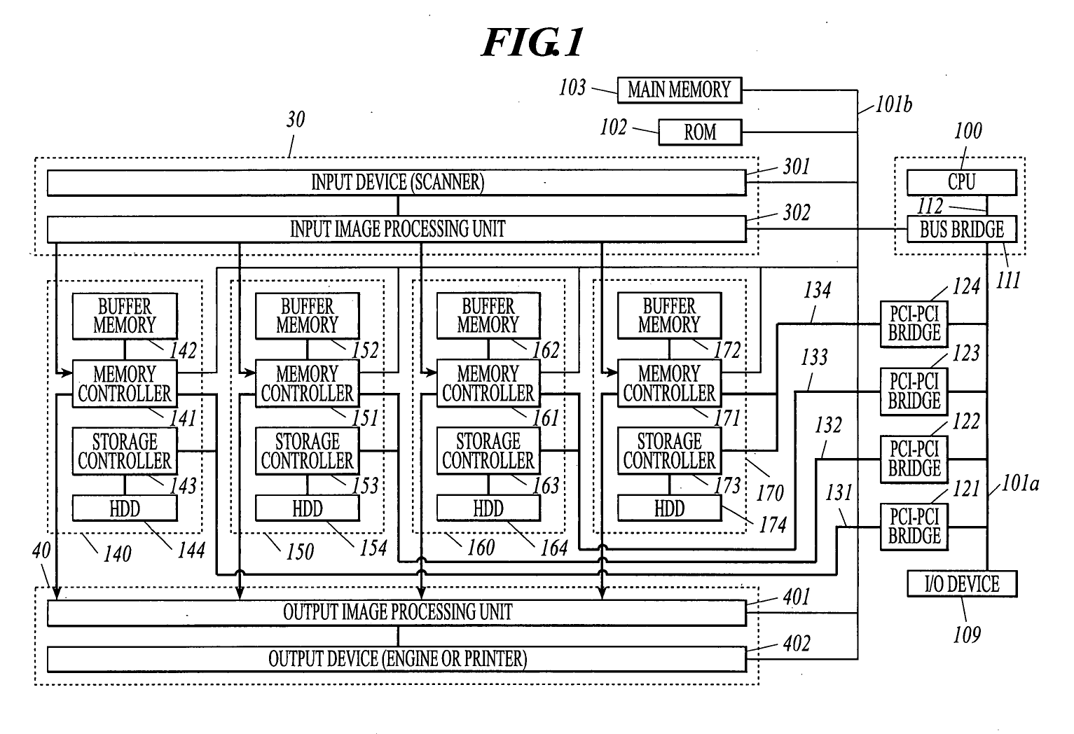

FIG. 1 shows a configuration of the image block 120 in FIG. 3 and the circuits around the image block 120. In detail, the system bus 101 of the CPU 100 in FIG. 3 is connected to the CPU 100 via a bus bridge 111 and a front side bus 112. Further, the system bus 111 is made up by separating into a PCI bus 101a and an ISA bus (Industrial Standard Architecture bus) 101b.

Incidentally, deferring from the present embodiment, the ISA bus 101b may be connected to the PCI bus 101a via a PCI-ISA bridge. Further, in the case where the CPU 100 itself comprises a PCI bus I/F, the PCI bus 101a may be directly connected to the CPU 100. The ROM 102, the main memory 103 and the like are connected to the ISA bus 101b.

Image data transfer buses 131 to 134 are connected to the PCI bus 101a via PCI-PCI bridges 121 to 124 respectively. The image data transfer buses 131 to 134 are made up as the PCI buses. Image memory blocks 140, 150, 160 and 170 for each basic color making up a color image, are connected to the image data transfer buses 131 to 134 respectively. Further, the print controller 104, the operation display unit 105, the network control unit 106 and the like are connected to the PCI bus 101a. In FIG. 1, these are collectively represented as an I/O device 109. Incidentally, although the read unit 30 and the printer unit 40 are the part of the I/O device, they are independently represented in FIG. 1 in order to show the input/output relationship with the image block 120. The I/O device 109, the read unit 30, the printer unit 40 and the image memory block 140, 150, 160 and 170 are controlled by the CPU 100.

The memory block 140 connected to the image data transfer bus 131 which is the local bus in the downstream of the PCI-PCI bridge 121, processes the image data of Y color among four basic colors. The image memory block 150 connected to the image data transfer bus 132 which is the local bus in the downstream of the PCI-PCI bridge 122, processes the image data of M color.

The memory block 160 connected to the image data transfer bus 133 which is the local bus in the downstream of the PCI-PCI bridge 123, processes the image data of C color among four basic colors. The image memory block 170 connected to the image data transfer bus 134 which is the local bus in the downstream of the PCI-PCI bridge 124, processes the image data of K color.

The image memory block 140 comprises a memory controller 141, a buffer memory 142, a storage controller 143, and a hard disk drive 144. The memory controller 141 is connected to the read unit 30 and the printer unit 40. The read unit 30 comprises an input device 301 and an input image processing unit 301. The input device 301 comprises a color CCD (a line image sensor) 36 (refer to FIG. 2), and obtains the reflected lights of R color, G color and B color from the reflected light from the original. The input image processing unit 302 converts the reflected lights of R color, G color and B color obtained by the input device 301, into the density data of Y color, M color, C color and K color, and outputs the density data as the image data, to the image memory block 140, 150, 160 and 170. On the other hand, the printer unit 40 as the image formation unit comprises an output image processing unit 401 and the output device 402. The output image processing unit 401 converts the density data which is received from the memory controller 141, into laser drive data. The output device 402 comprises laser units 55Y, 55M, 55C and 55K, and drives a laser diode for image formation of each color on the basis of the laser drive data generated by the output image processing unit 401.

The memory controller 141 is connected to the image data transfer bus 131. Further, the memory controller 141 inputs the timing signal and the image data of Y color outputted from the input image processing unit 302, and writes the image data of Y color in the buffer memory 142 in series while synchronizing with the timing signal.

Further the memory controller 141 reads the image data of Y color stored in the buffer memory 142 while synchronizing with the timing signal outputted from the output image processing unit 146, and outputs the image data of Y color to the output image processing unit 401. Thus, the memory controller 141 executes the input/output processing of the image data between the input device 301 or the output device 402 and the buffer memory.

Moreover, the memory controller 141 writes the data in the image data transfer bus 131 into the buffer memory 142 according to the access request from the image data transfer bus 131 side. Further, the memory controller 141 outputs the data read out from the buffer memory 142, to the image data transfer bus 131. In addition, the memory controller 141 adjusts an access collision so as to give preference to the access request from the input image processing unit 302 and the output image processing unit 401 over the access request from the image data transfer bus 131 side.

The buffer memory 142 comprises a semiconductor memory capable of high-speed access. For example, an SDRAM is used as the buffer memory 142. The capacity of the buffer memory 142 may be set arbitrarily. The capacity of the buffer memory 142 may be set so as to store the image data of Y color for several pages, and preferably, for several tens of pages.

The storage controller 143 is the circuit for controlling the read/write of the data from/into the hard disk drive 144 connected under the control thereof, and is connected to the image data transfer bus 131. In addition, the storage controller 143 executes the transfer processing of the data between the memory controller 141 and the storage controller 143. The storage controller 143 performs as the bus master to execute the burst transfer of the data between the memory controller 141 and the storage controller 143.

Incidentally, by transferring the data between the memory controller 141 and the storage controller 143, the data is actually transferred between the buffer memory 142 and the hard disk drive 144. The hard disk drive 144 has capacity sufficiently larger than that of the buffer memory 142. However, the access speed of the hard disk drive 144 is slower than that of the buffer memory 142.

The memory controller 141 gives preference to the access from the input image processing unit 302 and the output image processing 401 over the access from the image data transfer bus 131 side. Thereby, the transfer processing of the image data between the memory controller 141 and the storage controller 143 is executed in the interval of the input/output processing of the image data from the input image processing unit 302 and/or the output image processing unit 401 side to the buffer memory 142. Incidentally, commands for instructing each of operations are sent from the CPU 100 to the input image processing unit 302, the output image processing unit 401 and the memory controller 141, through the ISA bus 101b. Further, being not shown, a compression/decompression unit for compressing and decompressing the image data is connected to the memory controller 141.

The image memory block 150 comprises a memory controller 151, a buffer memory 152, a storage controller 153, and a hard disk drive 154. The density data (the image data) regarding M color is inputted from the input image processing unit 302 to the memory controller 151. Further, memory controller 151 outputs the density data of M color to the output image processing unit 401.

The image memory block 160 comprises a memory controller 161, a buffer memory 162, a storage controller 163, and a hard disk drive 164. The density data (the image data) regarding C color is inputted from the input image processing unit 302 to the memory controller 161. Further, memory controller 161 outputs the density data of C color to the output image processing unit 401.

Similarly, the image memory block 170 comprises a memory controller 171, a buffer memory 172, a storage controller 173, and a hard disk drive 174. The density data (the image data) regarding K color is inputted from the input image processing unit 302 to the memory controller 171. Further, memory controller 171 outputs the density data of K color to the output image processing unit 401.

The image memory block 150, the image memory block 160 and the image memory block 170 comprise the same configurations and the same functions as those of the image memory block 140, except that they process the image data of M color, C color and K color instead of Y color, respectively. Therefore the detail explanations of the configurations and the functions will be omitted.

The bus bridges such as PCI-PCI bridge buses 121 to 124 are the devices for connecting a plurality of buses, and transfer the access request from the upstream to the downstream. The bus bridge recognizes the device connected to the downstream bus so that the bus bridge transfers only the data to be transferred to the downstream device, to the downstream. On the other hand, in the case where a bus master or a DMA (Direct Memory Access) controller are connected to the downstream bus, even the data is transferred between the downstream devices, this transfer does not occupy the upstream bus isolated by the bus bridges. Therefore, it is possible to transfer the data independently in each of the upstream bus and the down stream bus of the bus bridge, without affecting each other. Incidentally, the bus master and the DMA controller described above may be incorporated in the bus bridge.

The upstream bus and the downstream bus of the bus bridge may not always operate with the clock synchronized each other. Further, the operating frequencies of them may be different from each other within the capacity of a FIFO (First In, First Out) memory incorporated in the bus bridge. Moreover, it is allowed that one of them is a parallel bus and the other is a serial bus.

By connecting the image data transfer buses 131 to 134 to the PCI bus 101a via the PCI-PCI bridges 121 to 124 comprising the above functions, the CPU 100 can control the various types of I/O devices 109 through the PCI bus 101a, without being affected by the transfer processing of the image data executed by the memory controllers 141, 151, 161 and 171 through the image data transfer buses 131 to 134.

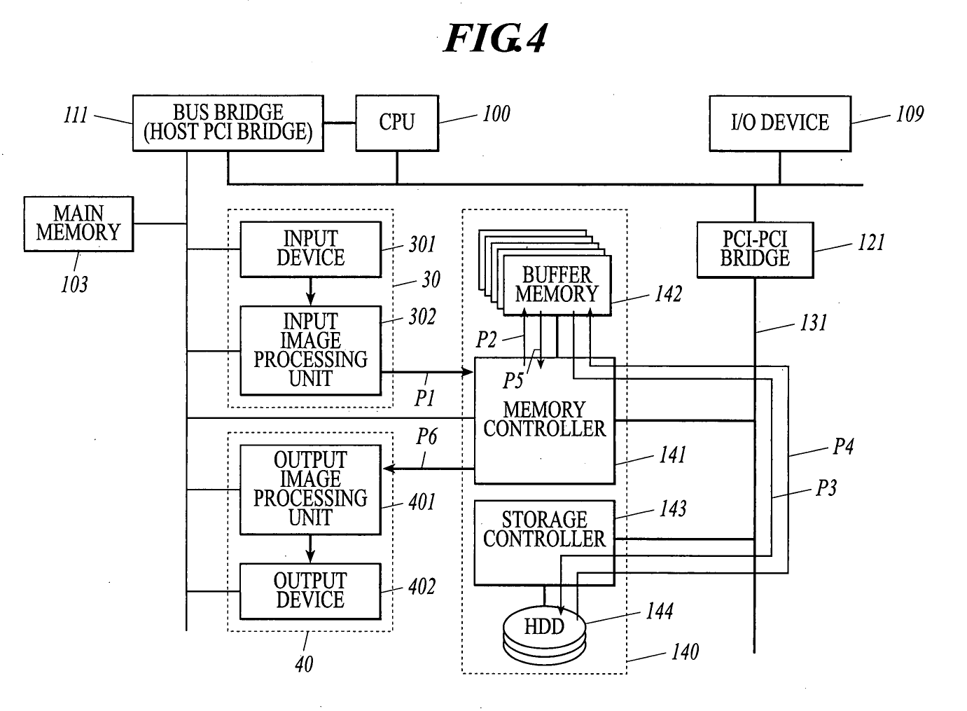

Next, the flow of the image data will be explained on the basis of FIG. 4. Incidentally, because the flow regarding each color is the same each other, FIG. 4 shows only the data flow in the image memory block 140 for Y color, for the simplification. The image data (the density data) of Y color, M color, C color and K color generated by executing the appropriate image processing in the input image processing unit 302 is inputted in the memory controllers 141, 151, 161 and 171 respectively (Path P1). Then, the image data compressed as needed is stored in the buffer memories 142, 152, 162 and 172 respectively (Path P2).

The image data stored in the buffer memories 142, 152, 162 and 172 are transferred to and temporarily stored in the hard disk drives 144, 154, 164 and 174 sequentially, via the image data transfer buses 131, 132, 133 and 134 respectively, by the burst transfer by the storage controllers 143, 153, 163 and 173 performing as the bus masters respectively (Path P3). Hereupon, because the image data transfer buses 131 to 134 are separated each other by the PCI-PCI bridges 121 to 124 respectively, it is possible that the transfer processing for each color in each of the image data transfer buses 131 to 134 is executed simultaneously.

When the image data is outputted to the printer unit 40, the processing for checking whether or not the image data to be outputted is stored in the buffer memories 142, 152, 162 and 172, and for transferring the necessary image data from the hard disk drives 144, 154, 164 and 174 to the buffer memories 142, 152, 162 and 172 in the case where the image data is not stored, is executed (Path P4). This transfer processing is executed via the image data transfer buses 131 to 134, by the burst transfer by the storage controllers 143, 153, 163 and 173 performing as bus masters respectively, similar to the above.

The image data stored in the buffer memories 142, 152, 162 and 172 are decompressed according to need, and after that, sequentially read according to the timing signal inputted from the printer unit 40 side (Path P5). Then, the image data are outputted to the output device 402 through the output image processing unit 401, and supplied to laser units 55Y, 55M, 55C and 55K of the corresponding color respectively (Path P6). Because the image data transfer buses 131 to 134 are separated each other by the PCI-PCI bridges 121 to 124 respectively, the transfer processing for each color in each of the image data transfer buses 131 to 134 is executed without being affected by the transfer processing for the other colors.

The processing for temporarily storing the image data from the buffer memories 142, 152, 162 and 172 to the hard disk drives 144, 154, 164 and 174 may be executed for all pages. However, hereupon, the processing is executed only in the case where the free spaces of the buffer memories 142, 152, 162 and 172 become smaller than a predetermined amount. For example, when the document of the few number of the pages is copied, because the image data for all the pages can be stored in the buffer memories 142, 152, 162 and 172, the image data is outputted from the buffer memories 142, 152, 162 and 172 directly to the printer unit 40, without being temporarily stored in the hard disk drives 144, 154, 164 and 174.

Each of the transfer processing between buffer memories 142, 152, 162 and 172 and the hard disk drives 144, 154, 164 and 174 is executed in the intervals of the input processing of the image data from the input image processing unit 302 to the buffer memories 142, 152, 162 and 172 and the output processing of the image data from the buffer memories 142, 152, 162 and 172 to the output image processing unit 401. For example, the transfer processing is executed while the input operation or the output operation of the image data is interrupted between pages.

Because the transfer processing is executed during the input/output processing as above, it is possible that the read unit 30 and the printer unit 40 continue the operation without slowing or stopping the operation in the middle of the page. Incidentally, in the case where the image data is outputted to the printer unit 40, the image formation processing by the printer 40 is started at the time that the image data for the minimum number of pages, which is to be outputted until the printer unit 40 is stopped after the activation, is prepared in the buffer memories 142, 152, 162 and 172.

As above, also in the case where the transfer processing of the image data is executed through the image data transfer buses 131 to 134, because these buses 131 to 134 and the PCI bus 101a are connected each other via the PCI-PCI bridges 121 to 124 respectively, it is possible that the CPU 100 executes the control of the I/O device 109 through the PCI bus 101a without being affected by the transfer processing in the image data transfer buses 131 to 134. Further, because the image data transfer buses 131 to 134 are also separated each other by the PCI-PCI bridges 121 to 124, it is possible that the transfer processing of the image data is executed in each the image data transfer buses 131 to 134 without being affected by the other buses, and it is possible to realize the high speed transfer.

Further, because the PCI bus 101a on the side of the CPU 100 and the image transfer buses 131 to 134 are connected each other via the PCI-PCI bridges 121 to 124 respectively, it is possible that the image data is read or written by accessing to the buffer memories 142, 152, 162 and 172 or the hard disk drives 144, 154, 164 and 174, from the side of the CPU 100, in case of necessity. Thereby, for example, it is possible that the image data developed by the print controller 104 is sent to the buffer memories 142, 152, 162 and 172 and printed out, or that the image data stored in the buffer memories 142, 152, 162 and 172 or the hard disk drives 144, 154, 164 and 174 is sent outside through the network control unit 106 or displayed on the display of the operation display unit 105. Consequently, it is possible to use the image data in various forms.

Next, the case where the image data transfer bus is shared by the plurality of basic colors will be explained.

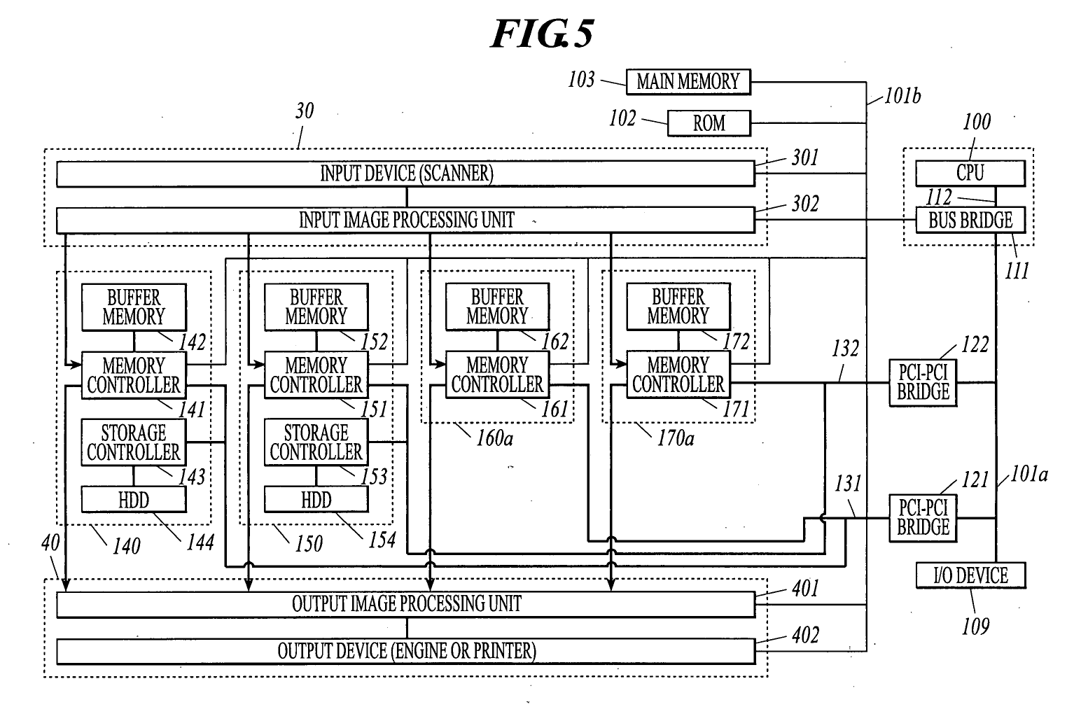

FIG. 5 shows the schematic circuit configuration of the image block where one image data transfer bus is shared by Y color and C color and the other image data transfer bus is shared by M color and K color. In FIG. 5, an image memory block 140 for Y color and an image memory block 160a for C color are connected to the image data transfer bus 131 which is the local bus in the downstream of the PCI-PCI bridge 121. Further, an image memory block 150 for M color and an image memory block 170a for K color are connected to the image data transfer bus 132 which is the local bus in the downstream of the PCI-PCI bridge 122. Further, the PCI-PCI bridges 123 and 124 shown in FIG. 1 and the image data transfer buses 133 and 134 which are the local buses in the downstream of the PCI-PCI bridges 123 and 124 are deleted in FIG. 5.

Further, the storage controller 163 and the hard disk drive 164 for C color of the image memory block 160 shown in FIG. 1 are deleted in FIG. 5. The storage controller 143 and the hard disk drive 144 of the image memory block 140 perform for Y color and C color. Similarly, the storage controller 173 and the hard disk drive 174 for K color of the image memory block 170 shown in FIG. 1 are deleted in FIG. 5. The storage controller 153 and the hard disk drive 154 of the image memory block 150 perform for M color and K color.

The above configuration is base on the followings; that is, because only one storage controller can perform as the bus master among one image data transfer bus at one time, even if the above device related to the transfer processing is shared, the performance on the transfer processing is not decreased. Of course, the configuration where the above devices are not shared may be available.

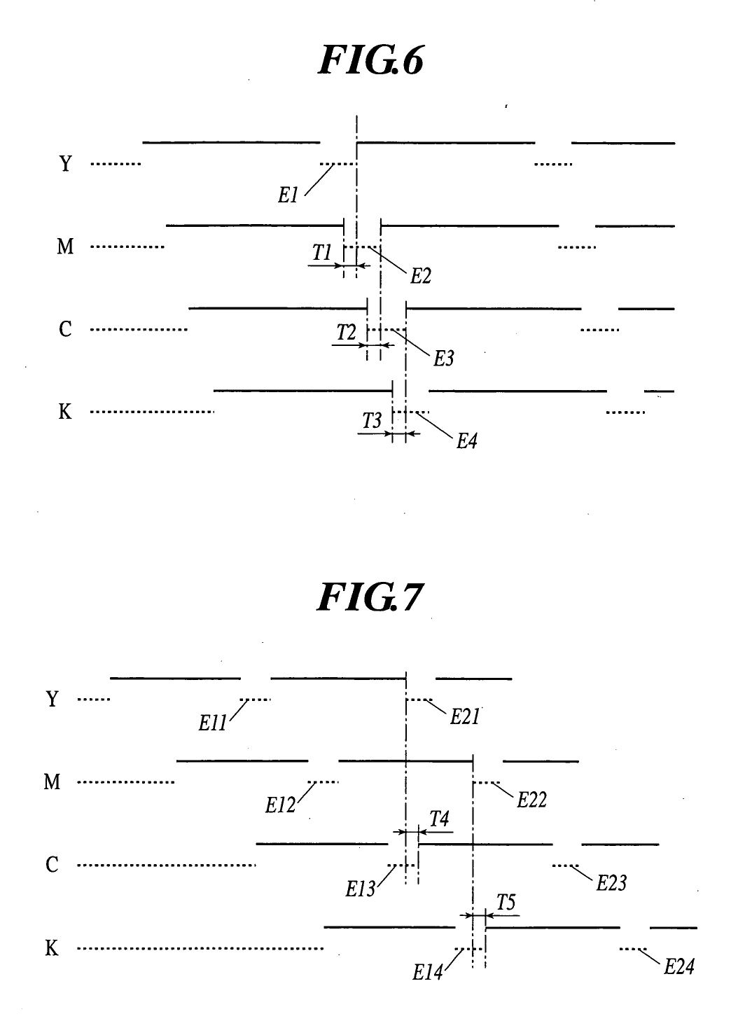

FIG. 6 shows an example of the relationship between an image formation period in which the output processing of image data to the printer unit 40 is executed and an executable period in which the transfer processing via the image data transfer bus can be executed. In FIG. 6, the image formation period is represented by a solid line and the period between the image formation periods is represented by a broken line. Each image formation for each basic color is executed corresponding to the rotation of the intermediate transfer belt 41, in the order of Y, M, C, and K, with some time lag. Therefore, as shown in FIG. 6, each of the image formation periods for each basic color is shifted by the time lag.

The output processing of the image data from the buffer memories 142, 152, 162 and 172 to the printer unit 40, which is executed during the image formation, is executed in preference to the transfer processing. Therefore, the executable period for the transfer processing is the interval in which the image formation is not executed. Mostly, the interval between pages in which the image formation is not executed, is the executable period for the transfer processing.

According to FIG. 6, the executable period E1 on Y color and the executable period E2 on M color are overlapped each other in a period T1, and the executable period E2 on the M color and the executable period E3 on the C color are overlapped each other in a period T2. Further, the executable period E3 and the executable period E4 on the K color are overlapped each other in a period T3. As above, when the image data transfer bus is shared by colors the executable periods for which are overlapped each other, the executable period for the transfer processing in the image data transfer bus is decreased by the overlapped period, in comparison with the case where the image data transfer bus is not shared.

Therefore, in the case where the image formation is executed with the timing as shown in FIG. 6, it is not preferable that the image data transfer bus is shared by the combination of “Y color and M color” and “C color and K color”.

On the other hand, the executable period E1 for Y color and the executable period E3 for C color are not overlapped each other, and the executable period E2 for M color and the executable period E3 for K color are not overlapped each other. Therefore, when the image data transfer bus is shared by the combination of colors for which the order of the image formation is not adjacent to each other, such as “Y color and C color” and “M color and K color” as shown in FIG. 5, without decreasing the executable period for the transfer processing, it is possible to obtain the performance of the transfer processing which has no difference from that in the case where the image data transfer bus is not shared.

Incidentally, the output processing of the image data from the buffer memories 142, 152, 162 and 172 to the printer unit 40 is directly executed by the memory controllers 141, 151, 161 and 171, not via the image data transfer bus. Therefore, even if the image data transfer bus is shared by a plurality of colors, it is possible to execute the output processing for each basic color independently and in parallel.

When the colors for which the order of the image formation is not adjacent to each other are combined as above, two colors to be outputted in first (Y color and M color, in this embodiment) are provided to the different image data transfer buses respectively. Therefore, it is possible to carry out the transfer processing simultaneously and in parallel without receiving interference each other, and to efficiently prepare the image data required for the output, in the buffer memories 142, 152, 162 and 172.

FIG. 7 shows another example of the relationship between the image formation period and the executable period for the transfer processing. According to FIG. 7, the lags of the timing when the image formation is started are large between the basic colors. Further, in the same page, the executable periods E11, E12, E13 and E14 for each basic color are not overlapped each other.

However, the executable period E13 for C color is overlapped with the executable period E21 for Y color of the next page, in a period T4. Further, the executable period E14 for K color is overlapped with the executable period E22 for M color of the next page, in a period T5. Therefore, in view of the continuous printing for a plurality of pages, the combinations such as {Y color, C color} and {M color, K color} are not preferred because the executable period for the transfer processing is decreased by the overlapping. In such case, it is preferable that the image data is shared by the combination such as {Y color, M color} and {C color, K color} where the executable periods for the transfer processing are not overlapped each other even when the continuous printing is concerned.

As above, if the image data transfer bus is shared by combining colors so as not to overlap the executable periods for the transfer processing, or so as to decrease the overlapping, it is possible to simplify the configuration by decreasing the number of the components, without decreasing the performance regarding the transfer processing.

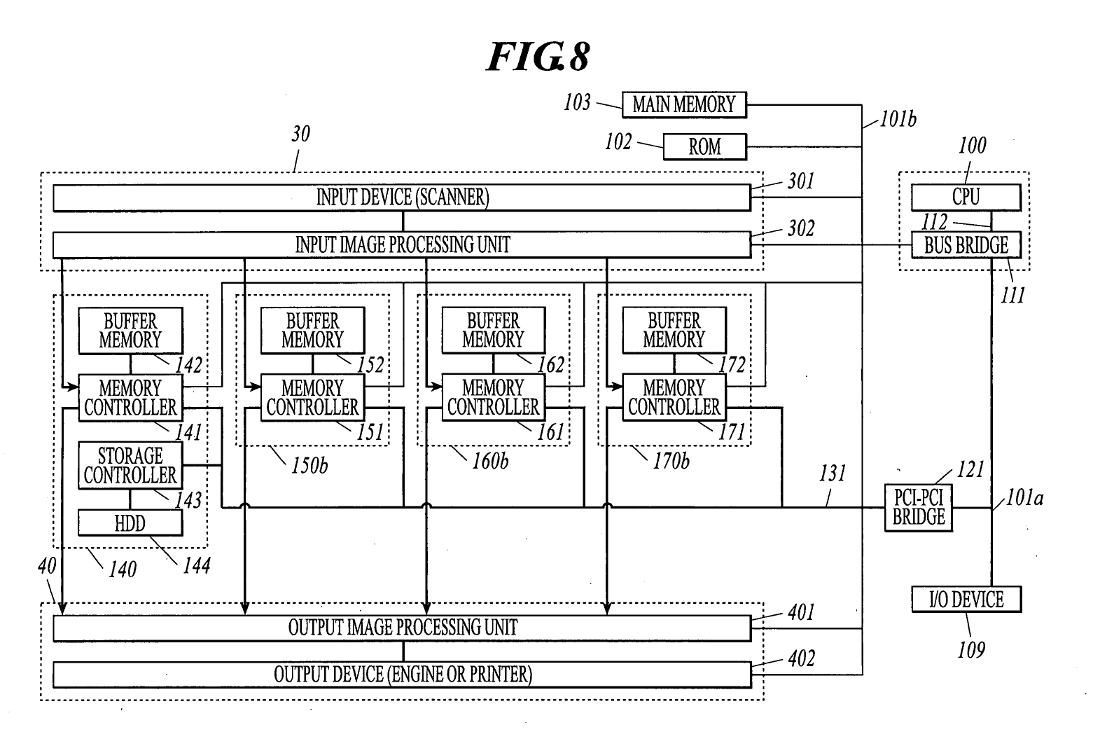

Incidentally, in the case where the overlapping is not occurred in the executable periods between all the basic colors or the overlapping is small, even in view of the continuous printing, the image memory blocks 140, 150b, 160b and 170b may be connected to one image data transfer bus 131 to share it, as shown in FIG. 8.

As above, the embodiment of the present invention is described by reference to the drawings. However, the concrete configuration is not limited to the present embodiment, and includes the change or the addition without departing from the scope of the present invention.

For example, in the present embodiment, the present invention is applied to the color digital copier. However, it may be applied to a color printer or a color complex machine. Further, because the amount of data is increased according to the high resolution and the multi gradation, the configuration that an image data transfer bus is connected to another bus via a bus bridge, similarly to the present invention, may be applied to an image processing apparatus intended for monochrome pictures.

Further, the bus bridge 111, the ROM 102 and the main memory 103 shown in FIG. 1 may be physically coupled with or separated from the CPU 100

Further, the I/O device 109 is not limited to that exemplified in the present embodiment. The I/O device 109 may be connected from the PCI bus 101a via a bus bridge such as a PCI-PCI bridge. Further, the types or the combination of the image data transfer buses 131 to 134 and the other buses 101a and 101b are not limited to those exemplified in the embodiment. For example, a PCI-X which is the future technology, a PCI Express which is a serial bus or the like can be used. Further, regarding the buses connected each other via a bus bridge, the clock frequencies may be the same each other, or be different from each other. Further, it does not matter whether the buses are synchronous or asynchronous. Moreover, the combination of the buses may be that of the parallel bus and the serial bus.

In the present embodiment, the hard disk drives 144, 154, 164 and 174 are used as the large-capacity storages for storing the image data. However, another rewritable storage such as a magnetooptical disk, a compact disk, a DVD or the like can be used.

In the present embodiment, the transfer controllers 147, 157, 167 and 177 perform the transfer. However, the transfer function may be arranged in other places or be incorporated in other devices. For example, a DMA controller may be provided separately, or the transfer function may be incorporated in the PCI-PCI bridges 121 to 124.

In the present embodiment, the SDRAM is used as the buffer memories 142, 152, 162 and 172. However, a memory of another type may be used, as long as it is capable of the high-speed access.

In addition, the basic colors composing a color image are not limited to Y, M, C and K, and the number of the basic colors is not limited to 4.

No. Tokugan 2004-032777 filed on Feb. 10, 2004 and No. Tokugan 2004-257077 filed on Sep. 3, 2004 including specification, claims, drawings and summary are incorporated herein by reference in its entirety.

1. An image processing apparatus comprising:
an input device for obtaining image data and/or an output device for outputting an image corresponding to the image data;
a buffer memory for temporarily storing the image data;
an input/output unit for executing input/output processing of the image data between the input device and/or the output device and the buffer memory;
a storage for storing the image data;
an image data transfer bus to which the buffer memory and the storage are connected; and
a transfer unit for executing transfer processing of the image data between the buffer memory and the storage through the image data transfer bus,
wherein the image data transfer bus is connected to another bus via a bus bridge.

2. The apparatus of claim 1,
wherein the apparatus deals with a color image,
the buffer memories, the input/output units, the storages, the image data transfer buses and the transfer units are provided for each of basic colors which forms the color image, and
each of the image data transfer buses is connected to another bus via the bus bridge.

3. The apparatus of claim 2 wherein a DMA transfer is independently executed in each of the image data transfer bus separated by the bus bridge.

4. The apparatus of claim 2, further comprising image memory blocks for each of the basic colors, each of the image memory blocks comprising the buffer memory, the input/output unit, the storage and the transfer unit,
wherein the image memory block is connected via the bus bridge, and controlled by one CPU.

5. The apparatus of claim 1 wherein the transfer processing is executed in an interval of the input/output processing.

6. An image processing apparatus comprising:
a plurality of image formation units for generating a plurality of images having each of basic colors in a predetermined order, and forming a color image on a sheet by superposing the plurality of images each other;
a plurality of buffer memories which are provided for each of the basic colors and temporarily store image data;
a plurality of output units which are provided for each of the basic colors and output the image data to the image formation unit for forming an image regarding any one of the basic colors from the buffer memories;
a plurality of image data transfer buses, the number of which is less than the number of the basic colors, and to which the buffer memories provided for each of the basic colors are connected so as not to connect the buffer memories for the basic colors adjacent to each other in the predetermined order, to the same image data transfer bus;
a plurality of storages connected for each of the image data transfer buses; and
a transfer unit for executing transfer processing of the image data between the storage connected to the image data transfer bus and the buffer memory, through the image data transfer bus, for each of the image data transfer buses.

7. An image processing apparatus comprising:
a plurality of image formation units for generating a plurality of images having each of basic colors in a predetermined order, and forming a color image on a sheet by superposing the plurality of images each other;
a plurality of buffer memories which are provided for each of the basic colors and temporarily store image data;
a plurality of output units which are provided for each of the basic colors and output the image data to the image formation unit for forming an image regarding any one of the basic colors from the buffer memory;
one or more image data transfer buses, the number of which is less than the number of the basic colors, and to which the buffer memories provided for each of the basic colors are connected so as not to overlap periods of an interval of processing for the buffer memories connected to the same image data transfer bus, the processing outputting the image data from the buffer memory to the image formation unit by the output unit corresponding to the basic color, or so as to decrease the overlapped period;
one or more storages connected for each of the image data transfer buses; and
a transfer unit for executing transfer processing of the image data between the storage connected to the image data transfer bus and the buffer memory, through the image data transfer bus, for each of the image data transfer buses.

8. The apparatus of claim 6 wherein each of the image data transfer buses is connected to another bus via a bus bridge.

9. The apparatus of claim 7 wherein each of the image data transfer buses is connected to another bus via a bus bridge.

10. The apparatus of claim 6 wherein the transfer processing is executed in each of the image data transfer buses, in an interval of processing that the output unit outputs the image data from the buffer memory to the image formation unit.

11. The apparatus of claim 7 wherein the transfer processing is executed in each of the image data transfer buses, in the interval of processing that the output unit outputs the image data from the buffer memory to the image formation unit.

12. An image processing apparatus comprising:
a central processing unit;
a bus to which the central processing unit is connected;
an image data transfer bus;
a bus bridge for connecting the bus and the image data transfer bus;
a buffer memory for temporarily storing image data, connected to the image data transfer bus;
a storage for storing the image data, connected to the image data transfer bus; and
a transfer unit for executing transfer of the image data between the buffer memory and the storage through the image data transfer bus.

13. The apparatus of claim 12 wherein the transfer unit realizes the transfer of the image data between the buffer memory and the storage, by a DMA transfer.

14. The apparatus of claim 12,
wherein the image processing apparatus deals with a color image,
the image data transfer buses, the bus bridges, the buffer memories, the storages and the transfer units are provided for each of basic colors of the color image.

15. The apparatus of claim 12, further comprising:
an image formation unit for forming an image on a sheet based on the image data; and
an output unit for outputting the image data from the buffer memory to the image formation unit.

16. The apparatus of claim 15,
wherein the image formation unit generates the images for each of basic colors in a predetermined order, and forms a color image by superposing the images for each of the basic colors,
the buffer memories and the image formation units are provided for each of the basic colors,
the plurality sets of the image data transfer bus, the storage and the transfer unit, the number of which is less than the number of the basic colors, are provided, and
the buffer memories provided for each of the basic colors are connected to the image data transfer buses so as not to connect the buffer memories for the basic colors adjacent to each other in the predetermined order, to the same image data transfer bus.

17. The apparatus of claim 16 wherein the transfer processing is executed in each of the image data transfer buses, in an interval of processing that the output unit outputs the image data from the buffer memory to the image formation unit.

18. The apparatus of claim 15,
wherein the image formation unit generates the images for each of the basic colors in a predetermined order, and forms a color image by superposing the images for each of the basic colors,
the buffer memories and the image formation units are provided for each of the basic colors,
a plurality sets of the image data transfer bus, the storage and the transfer unit, the number of which is less than the number of the basic colors, are provided, and
the buffer memories provided for each of the basic colors are connected to the image data transfer bus so as not to overlap periods of an interval of processing for the buffer memories connected to the same image data transfer bus, the processing outputting the image data from the buffer memory to the image formation unit by the output unit corresponding to the basic color, or so as to decrease the overlapped period.
